(19) United States
(12) Patent Application Publication
(10) Pub. No.: US 2006/0179880 A1
(43) Pub. Date: Aug. 17, 2006

(54) Products made from laminated-glass waste

(76) Inventor: Michael Joseph Haun, Santa Rosa, CA (US)

Correspondence Address: Michael J Haun, 5819 La Cuesta Drive, Santa Rosa, CA, 95409, US

(21) Appl. No.: 10/551,595

(22) PCT Filed: Apr. 12, 2004
(86) PCT No.: PCT/US04/11279

§ 371 Date: Sep. 30, 2005

(51) Int. Cl. C03B 31/00; C03B 23/02; C03B 29/00

(52) U.S. Cl. 65/23; 65/28; 65/61; 65/106; 65/111

(57) ABSTRACT

The invention provides a low-cost energy-saving method of manufacturing a glass product directly from laminated glass waste without having to crush the glass and separate the plastic interlayer, even when the glass is cracked. The method comprises heating laminated glass to fuse the glass layers and broken pieces of glass into a glass product. The plastic interlayer initially acts as a binder to hold the glass pieces together, but is then burned out during the heating prior to fusing the glass pieces together. Fusing laminated glass with cracked glass produces unique textures and patterns in the glass product. Coatings can also be applied to produce different colors and patterns in the glass product.

### CROSS REFERENCE TO RELATED APPLICATIONS

I claim the benefit of U.S. Provisional Application No. 60/462,417 which was filed on Apr. 11, 2003.

### BACKGROUND OF THE INVENTION

The invention is directed to products made from laminated glass, and a method for making products from laminated glass. Examples of products that can be made by the invention are wall tile, floor tile, roof tile, windowpanes, countertops, sinks, tabletops, or dinnerware, but other products can also be made. Any industrial or post-consumer laminated glass can be used in the invention. Preferably the laminated glass in the invention is laminated-glass waste. Laminated glass is manufactured for transportation and architectural applications by bonding two pieces of annealed or tempered flat glass together with a plastic interlayer, usually consisting of polyvinyl butyral (PVB). For applications requiring curved surfaces, such as windshields, the flat glass is heated and shaped prior to the lamination process.

Large volumes of laminated-glass waste result from damaged automobile windshields and safety-glass windows. There are also other major sources of laminated-glass waste, including rejected glass at manufacturing plants, and end-of-life vehicles. Laminated-glass waste is currently recycled by crushing the glass and separating the PVB interlayer. Ideally, the glass and PVB should be recycled back into the primary applications of flat glass and PVB interlayer. However, because of technical and economic reasons, recycling of flat glass and PVB are limited to mainly secondary applications, as discussed below.

Flat glass waste can be crushed (referred to as cullet) and remelted into new glass products as part of the raw material batch. Flat glass production is usually limited to only internal sources cullet, because of very demanding property requirements, such as transparency. External sources of cullet have larger variations in glass composition and contaminants, and thus generally cannot be used in flat glass production. For this reason, recycled flat glass is mainly used in secondary applications, such as cutlet for processing glass containers and fiber-glass insulation. Even though flat glass can be recycled, large volumes of flat glass are still disposed of in landfills.

The PVB interlayer from laminated-glass waste can be separated from the glass by crushing, but glass fragments tend to remain bonded to the PVB. Glass contamination limits the value of the PVB, and much of the PVB interlayer that is separated still ends up being disposed of in landfills. The glass contamination can be reduced by repeated crushing steps, however the cost of processing and energy required increases. Recycled PVB is used in secondary applications, such as flooring products.

Recycled glass can be sold as cullet to glass manufacturers for relatively low prices, similar to the cost of the raw materials that are replaced by the cullet. Recycled PVB is potentially worth many times that of recycled glass on a weight basis. However, only about five percent of the laminated glass is PVB, and thus the combined values of the recycled glass and PVB only amount to a few cents per pound of laminated-glass waste. The costs of collection, processing, and transportation of the waste materials with current methods greatly limit the economic viability of recycling laminated-glass waste. New processing methods and products are needed to improve the economics of laminated-glass waste recycling.

### BRIEF SUMMARY OF THE INVENTION

The present invention provides a low-cost energy-saving method of manufacturing a glass product directly from laminated glass waste without having to crush the glass and separate the plastic interlayer, even when the glass is cracked. The method comprises heating laminated glass to fuse the glass layers and broken pieces of glass into a glass product The plastic interlayer initially acts as a binder to hold the glass pieces together, but is then burned out during the heating prior to fusing the glass pieces together. The plastic interlayer also contributes fuel for the heating, which reduces the energy needed.

Heating laminated glass with cracked glass produces unique textures and patterns in the glass product. Each piece of the glass product has a different texture or pattern, because of the random fracture behavior of the glass. Multiple layers of laminated glass can be stacked to increase the thickness of the glass product. Coatings can be applied to one or more surfaces of the glass layers to vary the appearance of the glass product. The coatings allow different colors and patterns to be produced.

### DETAILED DESCRIPTION OF THE INVENTION

The main steps of the process comprise cutting laminated glass, cracking the glass, applying coatings, stacking layers of glass, and heating to fuse the glass pieces into a glass product. Depending on the laminated glass used and the desired product, not all of the main steps are required, as further discussed below. Additional processing steps can also be included to vary the appearance of the glass product without changing the scope of the invention. The main steps of the process, along with examples of additional steps, are discussed in more detail in the following paragraphs.

The first main step of the process comprises cutting the laminated glass into pieces of laminated glass. The laminated glass comprises two layers of glass bonded together by a plastic interlayer. The laminated glass is cut perpendicular to the interlayer. Any method of cutting the laminated glass can be used, but preferably the method results in smooth cut surfaces and edges, and maximizes the amount of glass remaining bonded to the plastic interlayer. One method for cutting the laminated glass is to use a saw for cutting ceramic or glass tile with a diamond-coated cutting wheel.

The laminated glass can be cut to the dimensions of the final glass product, or initially cut to larger dimensions and then cut to the final product dimensions after firing. The laminated glass can also be processed without initial cutting, and then optionally cut after firing. The pieces of laminated glass can be cut into a shape, including but not limited to a square, rectangle, triangle, polygon, circle, or oval shape.

The second main step of the process comprises cracking the pieces of laminated glass, Sources of laminated-glass waste are usually already at least partially cracked. The purpose of the second step of cracking the glass is to produce the desired cracked pattern in the final product. If the laminated glass already has the desired cracked pattern, then the step of cracking the glass is not required. The first and second steps can also be switched, where the laminated glass waste is cracked first and then cut into the pieces of cracked-laminated glass.

Any method of cracking the pieces of laminated glass can be used. Preferably, the cracking method minimizes crushing of the glass, and maximizes the amount of glass that remains bonded to the plastic interlayer. Examples of cracking methods include manually or mechanically impacting the surface of the glass to produce cracks, and passing the laminated glass through a series of rollers to bend and crack the glass. The cracked pattern can be varied from producing many small pieces of glass to producing only a few large pieces of glass.

The third main step of the method comprises optionally coating the pieces of cracked-laminated glass. The purpose of the coating is the control the appearance or properties of the glass product. The coating can be used to produce different colors, textures, and patterns, and to improve surface properties. A single coating or multiple coatings can be applied to any surface or combination of surfaces on the pieces of cracked-laminated glass. The coating comprises inorganic materials that withstand the heating temperatures needed to fuse the glass pieces together. The initial coating material can also contain organic material, but the organic material will burn out during the heating. Examples of coatings that can be applied include glazes, enamels, metal foil, thick-film pastes, thin-film layers, and powders.

The fourth main step of the process comprises stacking two or more of the cracked-laminated-glass pieces with optional coatings. Preferably, all of the pieces have about the same dimensions, and the first piece is placed on a surface with the plastic interlayer parallel to the surface, with each subsequent piece placed on top of, and aligned with, the preceding piece. Each piece of glass optionally has a coating applied. Any combination of pieces with and without coatings can be combined together into a stack. The coating and stacking steps provide a method of producing glass products with many different types of characteristics, including but not limited to:
a coating on an interior portion of the glass product,
a coating on an exterior surface of the glass product,
a glossy surface appearance on the glass product,
a textured surface appearance on the glass product,
a matte surface appearance on the glass product,
a transparent appearance in the glass product,
a translucent appearance in the glass product,
an opaque appearance in the glass product,
an interior or exterior coating to reflect light and/or heat from the glass product, and
an interior or exterior coating to absorb light and/or heat in the glass product.

Stacking and heating two or more pieces together provides a unique feature compared to if only one piece was processed. The cracks in a single piece extend through the piece, but when two are more pieces are stacked together, the cracks only extend through the entire stack where the cracks in each piece overlap. Because each piece has a different random pattern of cracks, the overlap of cracks between the pieces is limited. Stacking two of more pieces and limiting the overlap of cracks between the pieces, reduces the amount of glass flow needed during the fusing process to produce a continuous glass product.

The fifth main step of the process comprises heating or firing the stack of cracked-laminated-glass pieces with optional coatings into a fused glass product. Preferably a continuous kiln or furnace is used for heating, but a batch process can also be used. The plastic interlayer will burn out during heating. The heating rate and air supply need to be controlled, so that the burn out is complete prior to fusing the glass pieces. Complete burn out of the plastic interlayer will prevent carbon from becoming trapped in the fused glass. The firing profile of temperature and time required to fuse the glass pieces will depend on the composition of the glass in the laminated glass, and on the desired appearance and properties of the glass product The stack of cracked-laminated-glass pieces with optional coatings can be heated on a surface that minimizes the sticking of the glass to the surface. Release agents, also referred to as kiln washes, can be coated on the surface to prevent sticking. The surface that the laminated glass is heated on can be flat, curved, or textured with patterns, shapes, or designs. During heating the glass will slump and take the form of the surface to produce a glass product with features similar to the surface.

Additional processing steps can be included to further control the appearance and properties of the glass product if desired, without changing the scope of the invention. Examples of additional processing steps include cutting, applying coatings, reheating, and finishing the surfaces. The fused glass can be cut to smaller dimensions after heating, which will remove rounded edges, and produce well defined edges on the product. A coating or multiple coatings can also be applied to the surface of the glass after heating. A second heating or firing can then be used to fire the coating or coatings. If the edges were cut after heating, then a second heating can be used to produce smoother and more rounded edges on the final product Finishing the surfaces of the glass product can also be conducted by various methods including grinding, polishing, tumbling, etching, and sand blasting.

The following paragraphs provide 11 examples of the invention. The examples demonstrate how the invention can be used to make glass products from laminated glass. The glass products targeted by the examples are decorative glass tiles. Laminated-glass waste from a recycled automobile windshield with a thickness of about 0.2 inch was used as the source of laminated glass in the examples. The windshield glass was light-green colored. The plastic interlayer contained a blue color across part of the windshield, but this color burned out during firing. The windshield was cut into pieces with a diamond-coated cutting wheel on a saw designed for cutting ceramic tile. The pieces were washed with water, and dried in an oven at about 150° F. The pieces were heated or fired in a kiln on a ceramic refractory kiln shelf coated with kiln wash. The plastic interlayer burned out during the heating, prior to fusing the glass pieces together, In each example, a heating temperature and a hold time are given, which correspond to the maximum temperature during heating, and the hold time at the maximum temperature. The pieces were further processed as described in the following examples.

### EXAMPLE 1

A piece of laminated glass about 3 inches by 2 inches was cut from an automobile windshield. The piece was already cracked into many glass fragments, which were held together by the plastic interlayer, and thus was not further cracked. The piece was heated to 800° C. with a hold time of ten minutes. The two layers of glass, originally on either side of the plastic interlayer, fused together. The edges of the glass fragments also fused together to form a single piece of glass. The lower surface of the glass, which was on the kiln wash, was flat, while the top surface had a textured pattern of grooves, corresponding to the initial cracks. The grooves in the top surface resulted because the glass did not flow enough to form a smooth surface, but did flow enough to cause the edges of the glass fragments to become rounded, and the adjacent fragments to fuse together. The glass was transparent after heating, and did not stick significantly to the kiln wash. This example demonstrates how a textured top surface can be produced with a flat lower surface. However, because only a single piece of laminated glass was used, some of the grooves extended all the way through the sample, which would be undesirable for many applications.

### EXAMPLE 2

Two pieces of laminated glass, each about 4 inches by 4 inches, were cut from an automobile windshield. Both pieces were already cracked into glass fragments, which were held together by the plastic interlayer, and thus were not further cracked. One piece was stacked on top of the other piece with the edges of the pieces aligned. Each piece of laminated glass had two layers of glass and one layer of plastic. The stack therefore had four layers of glass, and two layers of plastic. The stack was heated to 770° C. with a hold time of thirty minutes. The four layers of glass, and the fragments of glass in each layer, fused together into a single piece of glass. The lower surface of the glass was flat, while the top surface had a textured pattern of grooves, which corresponded to the cracked pattern of the laminated-glass piece that was placed on top of the stack. The grooves in the top surface did not extend through the glass piece as occurred in Example 1, because two pieces of laminated glass with different patterns of cracking were fused together. However, the grooves were deeper with less rounded edges compared to Example 1.

### EXAMPLE 3

The same procedure described above for Example 2 was used for this example, except that the maximum heating temperature was increased to 790° C., and the top piece of laminated glass in the stack was cracked prior to placing the piece on the stack. The top piece was cracked manually by impacting the surface with a pestle. The lower surface of the fused glass was again flat, and the top surface was grooved with a texture corresponding to the cracked pattern of the top piece of laminated glass. The grooves in the top surface were more rounded, and shallower than those of the fused-glass sample of Example 2.

### EXAMPLE 4

The same procedure described above for Example 2 was used for this example, except that the maximum heating temperature was increased to 810° C. The lower surface of the fused glass was again flat, but the textured pattern on the top surface was much smoother than the samples of Examples 1-3.

### EXAMPLE 5

The same procedure described above for Example 4 was used for this example, except that a coating was applied to the upper surface of the upper laminated-glass piece. The coating comprised a dry powder mixture of 95 weight percent clear container glass (milled to <100 mesh) and 5 weight percent of a blue-colored ceramic stain. A layer of the mixture was spread on the surface. The heating caused the coating to fuse into a blue-colored glassy layer on the top surface of the fused-glass article. The top surface also had a textured pattern, which corresponded to the cracked pattern of the laminated-glass piece that was placed on top of the stack.

### EXAMPLE 6

The same procedure described above for Example 4 was used for this example, except that a coating was spread on the upper surface of the lower laminated-glass piece, prior to stacking the pieces. This resulted in a coating between the pieces of laminated glass. The coating was similar to the coating used in Example 5. The heating caused the coating to fuse into a blue-colored glassy layer in the middle of the fused-glass article. The top surface also had a textured pattern which corresponded to the cracked pattern of the laminated-glass piece that was placed on top of the stack.

### EXAMPLE 7

The same procedure described above for Example 6 was used for this example, except that the maximum heating temperature was changed to 790° C. The heating caused the coating to fuse into a blue-colored glassy layer in the middle of the fused-glass article, The top surface also had a textured pattern similar to that of Example 3.

### EXAMPLE 8

The same procedure described above for Example 3 was used for this example, except that an additional step was added. The additional step comprised cutting the edges of the fused-glass article with a diamond-coated wheel. This step removed the rounded edges, and produced well-defined edges on the article.

### EXAMPLE 9

The same procedure described above for Example 8 was used for this example, except that an additional step was added. The additional step comprised heating the article a second time to 790° C. with a hold time of thirty minutes. The article was heated with the same orientation as used in the first heating. This step produced smoother and more rounded edges on the article. The top surface had grooves that were more rounded and shallower than those of the fused-glass sample of Example 3.

### EXAMPLE 10

The same procedure described above for Example 8 was used for this example, except that an additional step was added. The additional step comprised heating the article a second time to 790° C. with a hold time of thirty minutes. The article was inverted (turned upside down) before heating the second time. This step produced smoother and more rounded edges on the article. The lower and top surfaces of the fused-glass article were flat without grooves, but within the article patterns were visible which corresponded to the cracked patterns in the laminated-glass pieces prior to the first heating.

### EXAMPLE 11

The same procedure described above for Example 3 was used for this example, except that the two pieces of laminated-glass were about 1 inch by 4 inches in size, and an additional step was included. The additional step comprised heating the stack of pieces on top of a stainless-steel mesh belt, instead of on the kiln wash. The top surface of the fused glass sample was similar to that of Example 3, but the lower surface had a grooved textured pattern, which corresponded to the pattern of the stainless-steel mesh belt. The fused-glass article was transparent, which allowed the pattern on the lower surface to be visible through the top surface.

A detailed description of the invention with examples was described above. It is understood that various other changes and modifications can be made to the present invention by those skilled in the art without departing from the scope of the invention. For example, additional coatings and finishing steps can be applied to the product if desired.

1. A method for making a glass product from laminated glass, comprising heating the laminated glass to:
burn out a plastic interlayer in the laminated glass, and
fuse glass in the laminated glass to form the glass product.

2. The method according to claim 1, wherein the laminated glass comprises laminated-glass waste, including but not limited to windshield or safety-glass waste.

3. The method according to claim 1, wherein the laminated glass comprises cracked glass held together by a plastic interlayer.

4. The method according to claim 1, further including breaking the laminated glass to form cracked glass held together by a plastic interlayer, prior to the heating.

5. The method according to claim 1, further including cutting the laminated glass into a shape, including but not limited to a square, rectangle, triangle, polygon, circle, or oval shape, prior to the heating.

6. The method according to claim 1, further including applying a coating to the laminated glass, prior to the heating.

7. The method according to claim 1, further including applying a glaze, enamel, metal foil, thick-film paste, thin-film layer, or powder to the laminated glass, prior to the heating.

8. The method according to claim 1, further including stacking two or more pieces of laminated glass, prior to the heating.

9. The method according to claim 1, further including:
selecting pieces of the laminated glass to provide pieces of uncoated laminated glass,
applying a coating to one or more pieces of the laminated glass to form pieces of coated laminated glass, and
stacking two or more pieces of laminated glass, selected from the pieces of coated laminated glass and the pieces of uncoated laminated glass, prior to the heating.

10. The method according to claim 1, further including:
selecting pieces of the laminated glass to provide pieces of uncoated laminated glass,
applying a glaze, enamel, metal foil, thick-film paste, thin-film layer, or powder to one or more pieces of laminated glass to form pieces of coated laminated glass, and
stacking two or more pieces of laminated glass, selected from the pieces of coated laminated glass and the pieces of uncoated laminated glass, prior to the heating.

11. The method according to claim 1, wherein the heating comprises a maximum temperature of about 700° C. to about 900° C.

12. The method according to claim 1, wherein the glass product is further processed by one or more additional steps, including but not limited to cutting, polishing, grinding, tumbling, etching, sand blasting, applying a coating, or reheating.

13. The method according to claim 1, wherein the glass product has a pattern corresponding to cracks present in the laminated glass prior to heating.

14. The method according to claim 1, wherein the glass product has one or more of the following characteristics:
a coating on an interior portion of the glass product,
a coating on an exterior surface of the glass product,
a glossy surface appearance on the glass product,
a textured surface appearance on the glass product,
a matte surface appearance on the glass product,
a transparent appearance in the glass product,
a translucent appearance in the glass product,
an opaque appearance in the glass product,
an interior or exterior coating to reflect light and/or heat from the glass product, and
an interior or exterior coating to absorb light and/or heat in the glass product.

15. The method according to claim 1, wherein the glass product comprises wall tile, floor tile, roof tile, windowpanes, countertops, sinks, tabletops, or dinnerware.

16. A method for making a glass product from laminated glass, comprising:
cutting the laminated glass into pieces,
stacking two or more of the pieces to form a stack, and
heating the stack to form the glass product.

17. The method according to claim 16, wherein the laminated glass comprises laminated-glass waste, including but not limited to windshield or safety-glass waste.

18. The method according to claim 16, wherein the laminated glass comprises cracked glass held together by a plastic interlayer.

19. The method according to claim 16, further including breaking the laminated glass, before or after the cutting, to form cracked glass held together by a plastic interlayer.

20. The method according to claim 16, wherein the pieces comprise a shape, including but not limited to a square, rectangle, triangle, polygon, circle, or oval shape.

21. The method according to claim 16, further including applying a coating to one or more of the pieces.

22. The method according to claim 16, further including applying a glaze, enamel, metal foil, thick-film paste, thin-film layer, or powder to one or more of the pieces.

23. The method according to claim 16, wherein the heating comprises:
burning out a plastic interlayer in the laminated glass, and
fusing glass in the laminated glass to form the glass product.

24. The method according to claim 16, wherein the heating comprises a maximum temperature of about 700° C. to about 900° C.

25. The method according to claim 16, wherein the glass product is further processed by one or more additional steps, including but not limited to cutting, polishing, grinding, tumbling, etching, sand blasting, applying a coating, or reheating.

26. The method according to claim 16, wherein the glass product has a pattern corresponding to cracks present in the laminated glass prior to heating.

27. The method according to claim 16, wherein the glass product has one or more of the following characteristics:
a coating on an interior portion of the glass product,
a coating on an exterior surface of the glass product,
a glossy surface appearance on the glass product,
a textured surface appearance on the glass product,
a matte surface appearance on the glass product,
a transparent appearance in the glass product,
a translucent appearance in the glass product,
an opaque appearance in the glass product,
an interior or exterior coating to reflect light and/or heat from the glass product, and
an interior or exterior coating to absorb light and/or heat in the glass product.

28. The method according to claim 16, wherein the glass product comprises wall tile, floor tile, roof tile, windowpanes, countertops, sinks, tabletops, or dinnerware.
